(19) United States
(12) Patent Application Publication
(10) Pub. No.: US 2024/0176596 A1
(43) Pub. Date: May 30, 2024

(54) VIRTUAL-REALITY-BASED SOFTWARE DEVELOPMENT

(71) Applicant: INTERNATIONAL BUSINESS MACHINES CORPORATION, ARMONK, NY (US)

(72) Inventors: Sarbajit K. Rakshit, Kolkata (IN); Vinod A. Valecha, Pune (IN)

(21) Appl. No.: 18/060,206

(22) Filed: Nov. 30, 2022

(51) Int. Cl. G06F 8/34; G06F 8/33; G06T 19/00

(52) U.S. Cl. CPC G06F 8/34; G06F 8/33; G06T 19/006

(57) ABSTRACT

According to one embodiment, a method, computer system, and computer program product for collaborative software development in mixed reality is provided. The present invention may include rendering a three-dimensional integrated development environment (3D IDE) within a mixed-reality environment; responsive to confirming credentials of a plurality of developers, admitting the plurality of developers to the mixed-reality environment; monitoring interactions between the plurality of developers and the 3D IDE within the mixed-reality environment; and responsive to the interactions, updating and displaying changes to the 3D IDE within the mixed-reality environment.

### BACKGROUND

The present invention relates, generally, to the field of computing, and more particularly to software development.

The field of software development is the field concerned with the conception, design, coding, documentation, testing, and bug fixing involved in creating and maintaining computer programs. Software development involves writing and maintaining the source code, but in a broader sense, it includes all processes from the conception of the desired software through to the final manifestation of the software, typically in a planned and structured process. Software development also includes research, new development, prototyping, modification, reuse, re-engineering, maintenance, or any other activities that result in software products.

### SUMMARY

According to one embodiment, a method, computer system, and computer program product for iteratively improving a virtual model of an object to be printed in a mixed reality environment is provided. The present invention may include rendering a three-dimensional integrated development environment (3D IDE) within a mixed-reality environment; responsive to confirming credentials of a plurality of developers, admitting the plurality of developers to the mixed-reality environment; monitoring interactions between the plurality of developers and the 3D IDE within the mixed-reality environment; and responsive to the interactions, updating and displaying changes to the 3D IDE within the mixed-reality environment.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a mixed-reality software development process according to at least one embodiment; and

FIG. 3 is a diagram illustrating a use case of a mixed-reality software development system according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to software development. The following described exemplary embodiments provide a system, method, and program product to, among other things, render a three-dimensional integrated development environment (IDE) within a mixed-reality environment, and enable multiple users to simultaneously interact with a code through a three-dimensional interface.

As previously described, the field of software development is the field concerned with the conception, design, coding, documentation, testing, and bug fixing involved in creating and maintaining computer programs. Computer programs, at their most basic level, comprise a series of instructions in machine language that change the state of a computer. Machine language consists of a series of binary values which, while understandable by a processor, is extremely difficult for a human being to read and write. To facilitate the process of software development, tools have been created to strongly abstract the programming process from the impenetrable details of machine language by, for example, allowing programmers to write code in programming languages that more closely mimic natural language, and which are therefore more intuitive to the human brain. Additionally, tools such as graphical user interfaces enable users to interact with electronic devices and software programs by direct manipulation of graphical elements, which is far more efficient and intuitive than, for example, purely text-based interfaces. A software application offering a comprehensive suite of such tools adapted specifically to the purpose of software programming may be referred to as an integrated development environment, or IDE. An IDE normally consists of at least a source code editor, build automation tools, and a debugger. Some IDEs further contain a compiler, interpreter, or both; others do not.

IDEs are designed to maximize programmer productivity by providing tight-knit components with similar user interfaces, and by presenting a single program within which all development is done. This program typically provides many features for authoring, modifying, compiling, deploying, and debugging software. One way in which the IDE improves productivity is in reducing the configuration necessary to piece together multiple development utilities. Instead, the IDE provides the same set of capabilities as one cohesive unit. Reducing setup time can increase developer productivity, especially in cases where learning to use the IDE is faster than manually integrating and learning all of the individual tools. Tighter integration of all development tasks has the potential to improve overall productivity beyond just helping with setup tasks. For example, code can be continuously parsed while it is being edited, providing instant feedback when syntax errors are introduced, thus allowing developers to debug code much faster and more easily with an IDE.

In the process of developing software within any given IDE, a software developer may develop the software code by manipulating elements of the graphical user interface and/or by entering textual code into the program. The developer may have to select various functions from the toolbar of the IDE and return to a text editor to work on software code. Consequently, the speed and efficiency of a developer may depend on how intuitive the graphical user interface of the IDE is, and by extension, how quick and easy it is for the developer to learn and use the graphical user interface. Furthermore, for any given software program under development, multiple developers may be working on developing the software program, and multiple developers may be accessing and making changes to the same code simultaneously, in some cases unknowingly; an IDE must therefore coordinate the work of multiple developers, to ensure that changes are tracked and stored such that one developer's work doesn't overwrite or otherwise damage or destroy the work of another.

Unfortunately, despite advances in software development including the advent of the IDE, the field still faces significant challenges. For example, many existing development tools do not support intra-team collaboration in the coding phase of software development; in other words, while collaboration may be supported in phases after the coding phase such as opening a bug report, uploading a progress report, and releasing a version, collaboration is not supported during the crucial phase of software development when the team of developers are working simultaneously to write code for a software program. This lack of support is embodied in the practical disadvantage that any individual developer is unable to ascertain whether code they intend to modify is currently being modified by another developer, which, depending on the versioning scheme, may lead to versioning issues, redundant work, destructively interfering code changes, et cetera. Additionally, software may comprise a number of modules or functions, upon which a number of other modules or functions depend; modifying code of a module or function may break all modules or functions that depend from the modified code. As such, if developers do not have a clear understanding of the dependencies and are uncoordinated in creating and modifying code, even minor changes can result in failures cascading throughout the code's dependencies.

The art has attempted to address these issues, for example, by attempting to model the dependencies of the various components of the software program and visualize the structure, subcomponents, and dependencies of a software program through abstract, easily readable visual elements. For example, some attempts represent a 3D visualization of code relations, such as dependency and relevance, and others represent the project management activities. This allows developers to easily comprehend the dependencies and broader shape of the software development process. However, attempts in the art to enable collaborations during coding phase have been largely limited to manual communication such as intra-team broadcast enquiry, which is a slow and inefficient method of conveying the very dense technical information of the software development process. Moving developers physically closer together such that they can collaborate in person is a logistically difficult and imperfect solution, as this requires developers working on the same project to be physically proximate, which may not be feasible or desirable for geographically decentralized development teams. As such, the practical effect of these collaboration challenges and the failures in the art in addressing them is that two or more developers are almost never assigned to the same code; software development is instead carefully parallelized such that developers work individually on separate subcomponents of the software.

The use of mixed-reality technology, when integrated with an improved IDE paradigm, may stand to offer significant advantages in how developers' interface with code, as well as addressing the challenges facing software development, including deficiencies with collaboration during the coding phase and coordination between multiple developers.

Mixed reality represents the technology of merging real and virtual worlds such that physical and digital objects co-exist and interact in real time. Mixed reality does not exclusively take place in either the physical or virtual worlds but is a hybrid of reality and virtual reality; as such, mixed reality describes everything in the reality-virtuality continuum except for the two extremes, namely purely physical environments and purely virtual environments. Accordingly, mixed reality includes augmented reality (AR) and virtual reality (VR). Augmented reality is a modem computing technology that uses software to generate images, sounds, haptic feedback, and other sensations which are integrated into a real-world environment to create a hybrid augmented reality environment, comprising both virtual and real-world elements. Virtual reality is a modern computing technology that creates a virtual environment that fully replaces the physical environment, such that a user experiencing a virtual reality environment cannot see any objects or elements of the physical world; however, the virtual reality environment is anchored to real-world locations, such that the movement of players, virtual objects, virtual environmental effects, and elements all occur relative to corresponding locations in the physical environment. Augmented reality is distinct from virtual reality in that an augmented reality environment augments the physical environment by overlaying virtual elements onto the physical environment, whereas a virtual reality environment fully replaces the physical environment with a virtual environment to completely immerse the user in a computer-generated world. In other words, a user within a virtual reality environment cannot see any real-world objects or environments, while a user within an augmented reality environment can see both the physical environment and virtual elements.

As such, it may be advantageous to, among other things, implement a system that implements an IDE within a mixed-reality environment that enables geographically disparate developers on a development team to see and interact with each other, see and interact with code that any developer is working on in real-time or near-real-time, and which visualizes the software under development in a manipulable format to represent dependencies, task flow, relevance, et cetera. Therefore, the present embodiment has the capacity to improve the technical field of software development by enabling developers to collaborate more closely during the coding phase of software development such that multiple developers may work together on the same code, more intuitively see and interact with the IDE elements, and more easily visualize and comprehend the dependencies, tasks, components, et cetera of the software under development, thereby reducing errors, versioning, and source control issues, and improving the speed and efficiency of software development.

According to one embodiment, the invention is a method of rendering a three-dimensional integrated development environment in a mixed reality environment, and enable a plurality of users to participate in the mixed reality environment to collaboratively edit and interact with software under development through a three-dimensional programming interface.

In some embodiments of the invention, the mixed reality environment may be hybrid environment comprising both physical and virtual elements. The mixed reality environment may comprise a hybrid physical-virtual world which one or more users may enter, see, move around in, interact with, et cetera through the medium of a mixed-reality device. All users in a single mixed-reality environment may be able to see and/or interact with the same virtual objects and virtual elements, and may interact with virtual representations of each other. The mixed reality environment may include augmented reality environments wherein generated images, sounds, haptic feedback, and other sensations are integrated into a real-world environment to create a hybrid augmented reality environment, comprising both virtual and real-world elements. The mixed reality environment may include virtual reality environments which fully replace the physical environment with virtual elements, such that a user experiencing a virtual reality environment cannot see any objects or elements of the physical world; however, the virtual reality environments are anchored to real-world locations, such that the movement of users, virtual objects, virtual environmental effects and elements all occur relative to corresponding locations in the physical environment.

The mixed reality device may be any device or combination of devices enabled to record real-world information that the mixed reality program may overlay with computer-generated perceptual elements to create the mixed-reality environment; the mixed reality device may further record the actions, position, movements, et cetera of the user, to track the user's movement within and interactions with the mixed reality environment. The mixed reality device may display the mixed reality environment to the user. The mixed reality device may be equipped with or comprise a number of sensors such as a camera, microphone, accelerometer, et cetera, and these sensors and/or may be equipped with or comprise a number of user interface devices such as displays, touchscreens, speakers, et cetera. One or more of the sensors may be capable of capturing biometric data, and may accordingly be herein referred to as biometric sensors or biosensors. In some embodiments, the mixed reality device may be a headset that is worn by the viewer.

The three-dimensional integrated development environment, or 3D IDE may be a software tool that provides tools and features for authoring, modifying, compiling, deploying, and debugging software in a single package with a unified aesthetic, organization scheme, interface, et cetera. The 3D IDE may comprise one or more repositories comprising the code of the software under development, tools such as a source code editor, build automation tools, a debugger, a compiler, an interpreter, globalization tools, platform-switching tools, an extension mechanism for third party tools, a version control system, et cetera.

In some embodiments of the invention, the system may render the 3D IDE in the mixed reality environment. In some embodiments of the invention, the mixed-reality environment may comprise one or more virtual objects including visualizations of aspects of the software under development including representations of the code of the software under development, graphical representations of development tools such as a source code editor, build automation tools, a debugger, a compiler, an interpreter, globalization tools, platform-switching tools, et cetera. The 3D IDE may be inhabited by one or more users. Users, or developers, may be human programmers accessing the mixed-reality environment through a mixed-reality device. In some embodiments of the invention, users participating in the mixed reality environment may see and/or manipulate the virtual objects employing interface devices such as controllers, mice, keyboards, et cetera. In some embodiments of the invention, users may further edit apparent properties of the virtual objects, such as size, color, shape, et cetera. In some embodiments of the invention, users may only be able to see, edit, and/or manipulate virtual objects representing the code. In some embodiments, users may create a copy of a virtual object.

In some embodiments of the invention, the system may identify the credentials of each individual attempting to access the 3D IDE and may grant or deny access based on the credentials. For example, the system may render multiple 3D IDEs, one for each separate program under development, and may only allow developers who are part of the team assigned to each software program under development into the corresponding 3D IDE. In some embodiments of the invention, the system may grant a user access to the 3D IDE but may limit what code the user may access, modify, and/or view. For example, developers of a team assigned to a first software program under development may have full permissions with respect to that code, but developers assigned to a second software program which depends from the first software program may have full permissions with respect to the second software program but may only have permission to view the first software development, and may not be granted permission to modify it.

The mixed reality environment may further comprise avatars representing individual users within the mixed-reality environment. The avatar may be a visual representation of the user in the virtual world that the user can control. The position and movement of the avatar's head and hands may be mapped to the position and movement of the user's respective head and hands based on data from sensors including sensors embedded in mixed reality devices, such that the position and movement of the virtual avatar correspond to the real-world position and movement of the user. The user may interact with virtual objects and the 3D IDE within the mixed-reality environment through the avatar. The mixed-reality environment may comprise a space within which the avatars may move and interact under control of the users. In some embodiments of the invention, for example where the sensors comprise finger-tracking sensors, the system may support gesture-based recognition, allowing users to input commands to and interact with the system using gestures. For example, a user may select a distant virtual object by pointing at it, and by performing a beckoning gesture, summon the selected virtual object to the user's hand.

The users may access the virtual object or objects representing the code, or code representation, to see or modify the code that the code representation represents. While a developer is accessing code, other users may be able to see the particular code accessed by the developer, and may be able to see, for example, modifications made by the developer in real time, where the developer is looking in the code, what code the developer has selected, what code the developer has recently edited or changed from the previous version, et cetera. The code representation may be updated to reflect all edits made to the code or all copies of the code by other users in real time or near-real-time. Real-time, as referred to herein, may describe hardware and software system operation that is subject to a real-time constraint, for example from event to system response. Such real-time operations must guarantee a response within specified time constraints, which may be on the order of milliseconds, and sometimes microseconds. In some embodiments, the system may store one or more versions of the code representations, where each version represents edits made to the code representation and/or copies of the code representation within a discrete segment of time and/or by a specific user or group of users. The system may continually parse the code of the software program under development, providing instant feedback within the mixed-reality environment when syntax errors are introduced, thus allowing developers to debug code much faster and more easily with an IDE.

In some embodiments of the invention, the IDE may support a visual programming language, or VPL. The VPL may be any programming language that lets users create programs by manipulating program elements graphically rather than by specifying them textually. A VPL allows programming with visual expressions and/or spatial arrangements of text and graphic symbols, used either as elements of syntax or secondary notation. In some embodiments of the invention, the code representations may represent discrete sub-components of the software program under development, such as individual functions, modules, files, et cetera. The different code representations may comprise the various building blocks of a software program, which may be visually distinguished through color, shape, size, et cetera. The developer may create a program by selecting code representations from a menu, and placing corresponding virtual objects in the mixed-reality environment. The developer may select different functionalities and tools of the 3D IDE from a menu within the mixed reality environment to apply in developing the software. The developer may link the code representations with connectors such as arrows, lines or arcs which represent relations such as dependency and relevance. The developer may select entire configurations of code representations, comprising multiple connected virtual objects, and place them within the mixed-reality environment. While the graphical code is being developed by a developer in the mixed reality environment, other developers may assist the developer in creating graphically developed code, by adding code representations and connectors, or manipulating placed virtual objects or connectors.

In some embodiments of the invention, each of the developers can perform individual graphical development and can integrate their own and each other's individually developed code into the software under development, and into the 3D interface of the IDE in the virtual reality environment. The system may be enabled to perform gesture-based interaction on the individually graphically developed code. In some embodiments of the invention, the system may enable developers to remove one or more functionalities from any graphically developed code. In some embodiments of the invention, the system may identify how individually developed code is integrated and saved in the version control tool. A developer may select any code from the version control tool and, utilizing reverse engineering, the system may convert binary executable code back into source code files using a decompiler, and represent the reverse-engineered source code files as virtual objects in the 3D IDE. The system may enable multiple developers to then interact with the reverse-engineered code and/or the virtual object representing and/or comprising the reverse-engineered code, and may update their changes individually.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to render a three-dimensional integrated development environment (IDE) within a mixed-reality environment, and enable multiple users to simultaneously interact with a code through a three-dimensional interface.

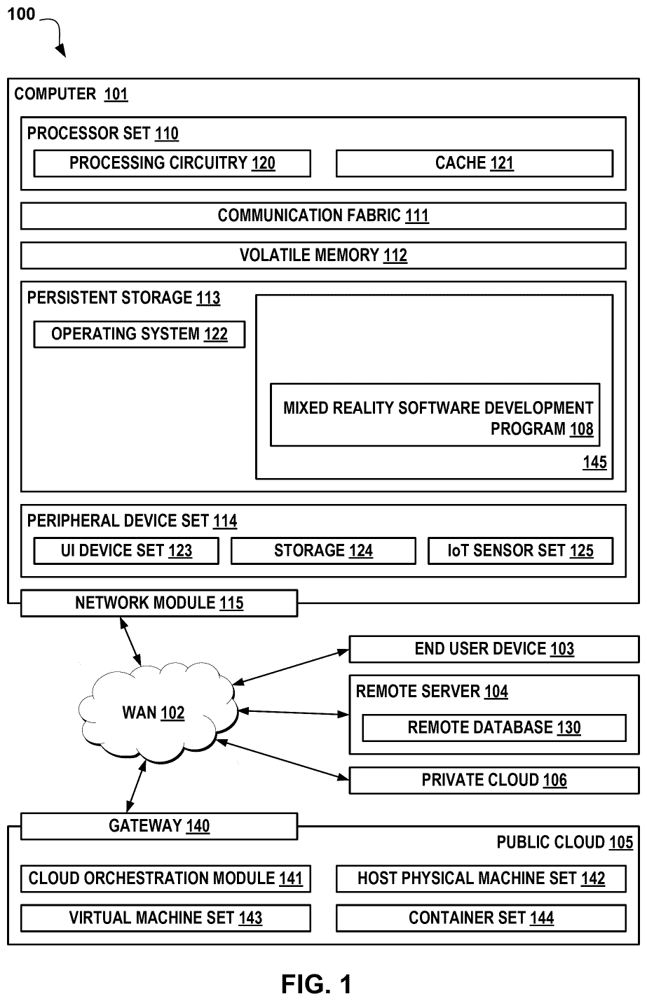

Referring now to FIG. 1, computing environment 100 contains an example of an environment for the execution of at least some of the computer code involved in performing the inventive methods, such as code block 145, which may comprise mixed-reality software development program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, mixed reality devices, wearable devices (such as goggles, virtual reality headsets, augmented reality headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may further comprise three-dimensional printers, which may be devices that utilize a computer-controlled extrusion device to deposit material in specific patterns on a substrate to create a three-dimensional object from a virtual model.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

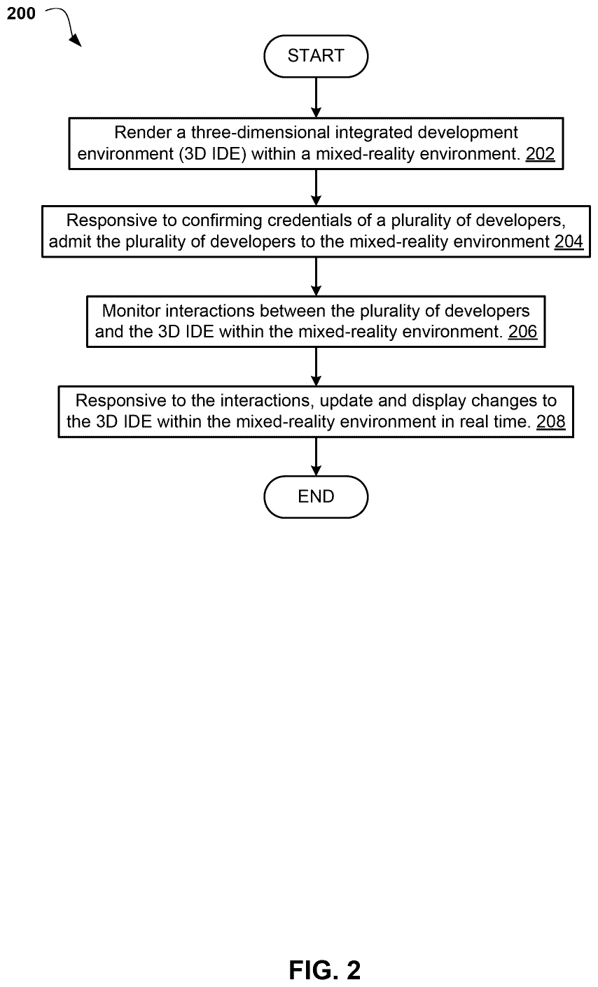

According to the present embodiment, the mixed-reality software development program 108 may be a program enabled to render a three-dimensional integrated development environment (IDE) within a mixed-reality environment, and enable multiple users to simultaneously interact with a code through a three-dimensional interface. The mixed-reality software development program 108 may, when executed, cause the computing environment 100 to carry out a mixed-reality software development process 200. The mixed-reality software development process 200 may be explained in further detail below with respect to FIG. 2. In embodiments of the invention, the mixed-reality software development program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, mixed-reality software development program 108 may be distributed in its operation over any number or combination of the aforementioned devices.

Referring now to FIG. 2, an operational flowchart illustrating a mixed-reality software development process 200 is depicted according to at least one embodiment. At 202, the mixed-reality software development program 108 renders a three-dimensional integrated development environment (3D IDE) within a mixed-reality environment. In some embodiments of the invention, the mixed-reality environment may comprise one or more virtual objects including visualizations of aspects of the software under development including representations of the code of the software under development, graphical representations of development tools such as a source code editor, build automation tools, a debugger, a compiler, an interpreter, globalization tools, platform-switching tools, et cetera. The mixed-reality software development program 108 may render the code of the software under development by simulating modules of the code as virtual objects which developers within the mixed reality environment can see, manipulate, move, and/or modify. In some embodiments of the invention, the mixed-reality environment may comprise multiple copies of the virtual objects.

At 204, the mixed-reality software development program 108 admits a plurality of developers to the 3D IDE responsive to confirming credentials. The mixed-reality software development program 108 may identify the credentials of each individual attempting to access the 3D IDE, and may grant or deny access based on the credentials. In some embodiments of the invention, the mixed-reality software development program 108 may grant a developer access to the 3D IDE but may limit what code the developer may access, modify, and/or view. The mixed reality environment may render the developers as avatars representing the individual developers within the mixed-reality environment. The avatar may be a visual representation of the developer in the virtual world that the developer can control. The position and movement of the avatar's head and hands may be mapped to the position and movement of the developer's respective head and hands based on data from sensors including sensors embedded in mixed reality devices, such that the position and movement of the virtual avatar correspond to the real-world position and movement of the developer. The developer may interact with virtual objects and the 3D IDE within the mixed-reality environment through the avatar. The mixed-reality environment may comprise a space within which the avatars may move and interact under control of the developers.

At 206, the mixed-reality software development program 108 monitors interactions between the plurality of developers and the 3D IDE within the mixed-reality environment. The mixed-reality software development program 108 may monitor how the developers interact with the virtual objects, graphical user interface elements, and other components comprising the 3D IDE within the mixed reality environment. The mixed-reality software development program 108 may monitor the movement of the developer by tracking the developer's movements via microlocation data from sensors integrated into the mixed reality device, and track the location and movement of the virtual model in relation to the developer for at least the duration of time that the developer is holding and/or regularly interacting with the virtual model. The mixed-reality software development program 108 may monitor where and how the developer holds, touches, or otherwise interacts with the virtual model, what surfaces, objects, and materials in the mixed-reality environment. The developer may interact with virtual objects and the 3D IDE within the mixed-reality environment through the avatar. The mixed-reality environment may comprise a space within which the avatars may move and interact under control of the developers. In some embodiments of the invention, for example where the sensors comprise finger-tracking sensors, the mixed-reality software development program 108 may support gesture-based recognition, allowing developers to input commands to and interact with the mixed-reality software development program 108 using gestures. For example, a developer may select a distant virtual object by pointing at it, and by performing a beckoning gesture, summon the selected virtual object to the developer's hand.

At 208, the mixed-reality software development program 108 updates and displays changes to the 3D IDE within the mixed-reality environment in real-time. The developers may access the virtual object or objects representing the code, or code representation, to see or modify the code that the code representation represents. While a developer is accessing code, other developers may be able to see the particular code accessed by the developer, and may be able to see, for example, modifications made by the developer in real time, where the developer is looking in the code, what code the developer has selected, what code the developer has recently edited or changed from the previous version, et cetera. The code representation may be updated to reflect all edits made to the code or all copies of the code by other developers in real time or near-real-time. In some embodiments, the mixed-reality software development program 108 may store one or more versions of the code representations, where each version represents edits made to the code representation and/or copies of the code representation within a discrete segment of time and/or by a specific developer or group of developers. The mixed-reality software development program 108 may continually parse the code of the software program under development, providing instant feedback within the mixed-reality environment when syntax errors are introduced, thus allowing developers to debug code much faster and more easily with an IDE.

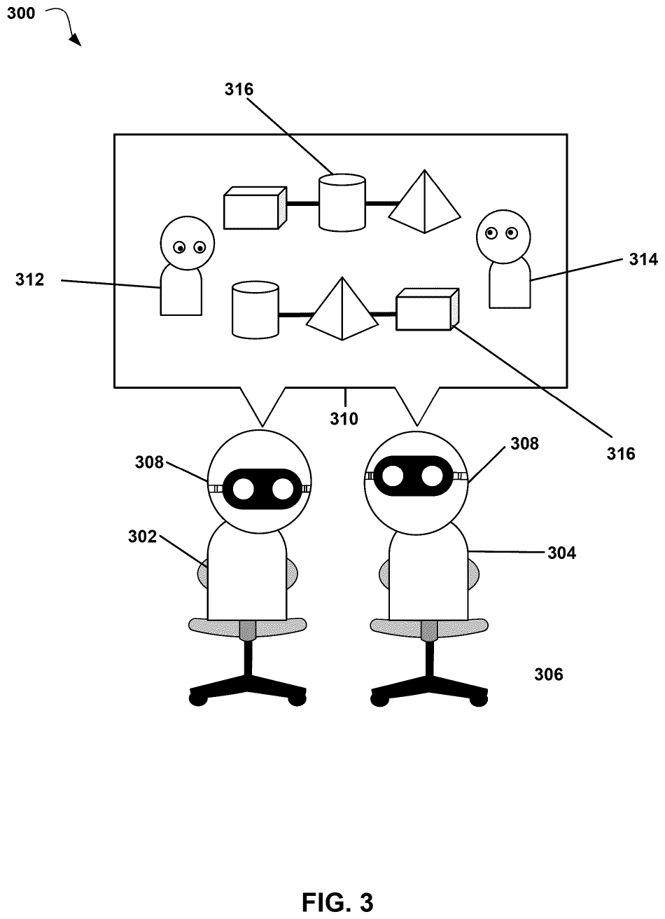

Referring now to FIG. 3, a diagram illustrating a use case of a mixed-reality software development system is depicted according to at least one embodiment. Here, a first developer 302 and a second developer 304 are located within a physical environment 306. Both the first developer 302 and the second developer 304 are wearing mixed-reality devices 308, which here comprise wearable headsets. Through the mixed-reality devices 308, the first developer 302 and the second developer 304 are able to access and interact with a mixed-reality environment 310. Within the mixed-reality environment 310, the first developer 302 is represented as a first avatar 312, and the second developer 304 is represented by a second avatar 314. Through the avatars, the first developer 302 and the second developer 304 are able to interact with the 3D IDE 316, which comprises, among other things, a number of shapes and connectors comprising, respectively, modules of the code under development and connectors illustrating the relationships between the modules.

It may be appreciated that FIGS. 2-3 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for collaborative software development in mixed reality, the method comprising:
rendering a three-dimensional integrated development environment (3D IDE) within a mixed-reality environment;
responsive to confirming credentials of a plurality of developers, admitting the plurality of developers to the mixed-reality environment;
monitoring interactions between the plurality of developers and the 3D IDE within the mixed-reality environment; and
responsive to the interactions, updating and displaying changes to the 3D IDE within the mixed-reality environment.

2. The method of claim 1, wherein modules of code comprising the 3D IDE are rendered as one or more virtual objects within the mixed-reality environment.

3. The method of claim 2, wherein the 3D IDE supports one or more visual programming languages.

4. The method of claim 1, wherein the interactions comprise gestures performed by the plurality of developers.

5. The method of claim 1, wherein the 3D IDE comprises one or more visualizations illustrating dependencies, tasks, and/or components comprising a plurality of software under development within the 3D IDE.

6. The method of claim 1, wherein a plurality of developers are enabled to simultaneously modify a plurality of code comprising a module of the 3D IDE.

7. The method of claim 1, wherein the changes to the 3D IDE are updated and displayed in real time.

8. A computer system for collaborative software development in mixed reality, the computer system comprising:
one or more processors, one or more computer-readable memories, one or more mixed-reality devices, one or more computer-readable tangible storage medium, and program instructions stored on at least one of the one or more tangible storage medium for execution by at least one of the one or more processors via at least one of the one or more memories, wherein the computer system is capable of performing a method comprising:
rendering a three-dimensional integrated development environment (3D IDE) within a mixed-reality environment;
responsive to confirming credentials of a plurality of developers, admitting the plurality of developers to the mixed-reality environment;
monitoring interactions between the plurality of developers and the 3D IDE within the mixed-reality environment; and
responsive to the interactions, updating and displaying changes to the 3D IDE within the mixed-reality environment.

9. The computer system of claim 8, wherein modules of code comprising the 3D IDE are rendered as one or more virtual objects within the mixed-reality environment.

10. The computer system of claim 9, wherein the 3D IDE supports one or more visual programming languages.

11. The computer system of claim 8, wherein the interactions comprise gestures performed by the plurality of developers.

12. The computer system of claim 8, wherein the 3D IDE comprises one or more visualizations illustrating dependencies, tasks, and/or components comprising a plurality of software under development within the 3D IDE.

13. The computer system of claim 8, wherein a plurality of developers are enabled to simultaneously modify a plurality of code comprising a module of the 3D IDE.

14. The computer system of claim 8, wherein the changes to the 3D IDE are updated and displayed in real time.

15. A computer program product for collaborative software development in mixed reality, the computer program product comprising:
one or more computer-readable tangible storage medium and program instructions stored on at least one of the one or more tangible storage medium, the program instructions executable by a processor to cause the processor to perform a method comprising:
rendering a three-dimensional integrated development environment (3D IDE) within a mixed-reality environment;
responsive to confirming credentials of a plurality of developers, admitting the plurality of developers to the mixed-reality environment;
monitoring interactions between the plurality of developers and the 3D IDE within the mixed-reality environment; and
responsive to the interactions, updating and displaying changes to the 3D IDE within the mixed-reality environment.

16. The computer program product of claim 15, wherein modules of code comprising the 3D IDE are rendered as one or more virtual objects within the mixed-reality environment.

17. The computer program product of claim 16, wherein the 3D IDE supports one or more visual programming languages.

18. The computer program product of claim 15, wherein the interactions comprise gestures performed by the plurality of developers.

19. The computer program product of claim 15, wherein the 3D IDE comprises one or more visualizations illustrating dependencies, tasks, and/or components comprising a plurality of software under development within the 3D IDE.

20. The computer program product of claim 15, wherein a plurality of developers are enabled to simultaneously modify a plurality of code comprising a module of the 3D IDE.
